(19) United States
(12) Patent Application Publication
(10) Pub. No.: US 2022/0337503 A1
(43) Pub. Date: Oct. 20, 2022

(54) IDENTIFYING ZERO REDUNDANCY PATHS AND AFFECTED ENDPOINTS IN A SOFTWARE DEFINED NETWORK

(71) Applicant: Cisco Technology, Inc., San Jose, CA (US)

(72) Inventors: Saravanan Sampathkumar, San Jose, CA (US); Kedhaar Ram Subramanian, Fremont, CA (US); Ajay Modi, San Jose, CA (US); Umamaheswararao Karyampudi, Fremont, CA (US)

(21) Appl. No.: 17/229,979

(22) Filed: Apr. 14, 2021

(51) Int. Cl. H04L 12/751; H04L 12/721; H04L 12/707; H04L 12/717

(52) U.S. Cl. CPC H04L 45/02; H04L 45/123; H04L 45/24; H04L 45/42

(57) ABSTRACT

A network controller maintains network availability between a pair of endpoints. The controller detects a topology of a computer network connecting endpoints. The controller determines a metric of availability between a first endpoint and a second endpoint. The metric of availability is based on non-overlapping paths between the first endpoint and the second endpoint. Responsive to a determination that the metric of availability satisfies a predetermined criterion, the controller adjusts a path between the first endpoint and the second endpoint.

### TECHNICAL FIELD

The present disclosure relates to software defined networks, especially redundancy and high availability in software defined networks.

### BACKGROUND

Zero redundancy network scenarios are common, due to improper network design. However, even in well-designed networks, configurational or operational changes, such as link failures or node (e.g., switch) failures, may introduce zero redundancy network paths between endpoints. Typically, network redundancy may be maintained through duplication of network links and/or packets, at the cost of doubling resource usage. For instance, network redundancy at Layer 2 may be provided by the Packet Redundancy Protocol (PRP). Using PRP, each endpoint requires connectivity to the network via two ports, with the ports connected to different, isolated Local Area Networks (LANs). Duplicate copies of every packet are sent from the different ports through the different LANs, and the receiving endpoint discards the duplicate copies. There is no distinction between active and backup paths in PRP.

### BRIEF DESCRIPTION OF THE DRAWINGS

FIG. 1 is a simplified block diagram of a Software Defined Network (SDN) system, according to an example embodiment.

FIG. 2 is a simplified block diagram of an SDN fabric illustrating articulation points and isolated bridges, according to an example embodiment.

FIG. 3 is a simplified block diagram illustrating resolutions to a failure lowering the availability between two endpoints, according to an example embodiment.

FIG. 4 is a flowchart illustrating operations performed on a network controller to measure and resolve availability between endpoints connected to a computer network, according to an example embodiment.

FIG. 5 illustrates a simplified block diagram of a device that may be configured to perform the methods presented herein, according to an example embodiment.

### DESCRIPTION OF EXAMPLE EMBODIMENTS

### Overview

A computer implemented method is provided for maintaining network availability between a pair of endpoints in a network. The method includes detecting a topology of a computer network connecting a plurality of endpoints. The method also includes determining a metric of availability between a first endpoint of the plurality of endpoints and a second endpoint of the plurality of endpoints. The metric of availability is based on non-overlapping paths between the first endpoint and the second endpoint. Responsive to a determination that the metric of availability satisfies a predetermined criterion, the method includes adjusting a path between the first endpoint and the second endpoint.

### EXAMPLE EMBODIMENTS

A single point of failure is defined as a potential risk posed by a flaw in the design, implementation, or configuration of a system in which one fault or malfunction causes an entire system to stop operating. In a network fabric, if there are links or nodes that present a single point of failure, any additional link/node failure could potentially lead to the network being split into disjoint sub-networks without mutual connectivity. From an application perspective, this network scenario might result in a loss of application availability. For instance, if an application server and the corresponding application storage are split into different sub-networks, the application server will not be able to access any data, leading to an application outage.

In a modern network fabric, it is not feasible to use duplicative methods, such as PRP, for providing redundancy guarantees due to the doubling of network resource cost and network traffic. The techniques presented herein provide a method to ensure high network availability between endpoint pairs using Software Defined Networking (SDN). The techniques include defining a metric to track high network availability between a pair of endpoints, dynamically identifying outages of high network availability, and tracking the network availability between endpoints with a complexity scaled to the number of network elements instead of to the number of endpoints connected to the network fabric.

The techniques presented herein may be applied in multiple use cases. In one use case, network controllers may be deployed in clusters in an SDN fabric. If the controllers are separated by a network partition, the controllers may not be able to coordinate the different clusters of the SDN fabric. To resolve this “split brain” scenario, the network controller processes are stopped, the network partition issue is fixed, the network controller state is rolled back to a stable state (i.e., before the network partition), and the network controller processes are restarted. Enforcing high network availability between network controllers prevents this scenario, which may be complex and challenging to resolve after a failure.

In another use case, reliable data storage may be provided across various transport mechanisms. Typical Non-Volatile Memory over Fabric (NVMe-oF) solutions have three transport mechanisms: Fibre Channel, Remote Data Memory Access (RDMA) over Converged Ethernet version 2 (RoCEv2), and Transport Control Protocol. Fibre Channel provides high availability between storage-server endpoint pairs by having two fabrics available and using fabric failover in the event of unexpected failures. RoCEv2 and TCP fabrics use Internet Protocol (IP) and Ethernet in the lower layers, and do not typically ensure high availability built into the protocols. Monitoring network availability according to the techniques presented herein ensures high availability between server endpoints and storage endpoints using any transport mechanism.

Additionally, distributed user applications may benefit from the availability tracking according to the techniques presented herein. High network availability ensures the distributed user applications maintain consistent states.

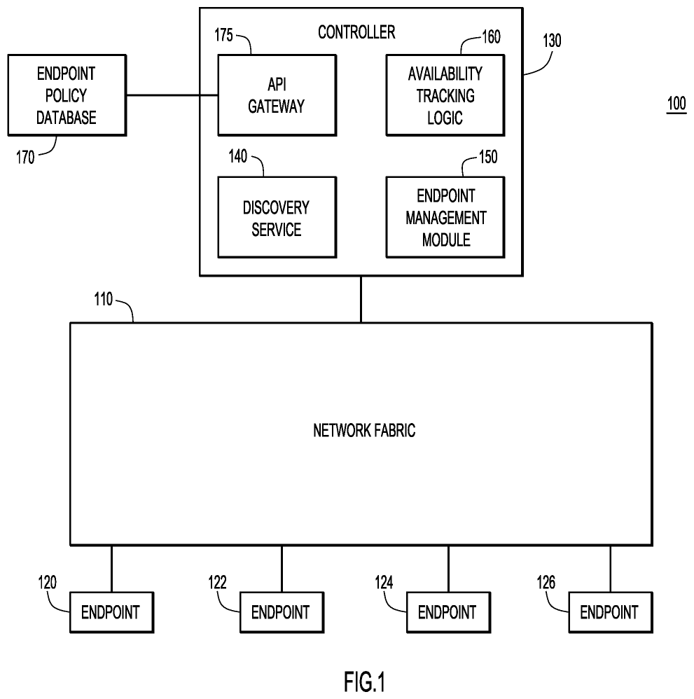

Referring now to FIG. 1, a simplified block diagram of a network system 100 is shown. The network system 100 includes a network fabric 110 connecting endpoints 120, 122, 124, and 126. The network fabric 110 may include virtual or physical network elements (e.g., switches, routers, etc.) configured in a network topology. The endpoints 120, 122, 124, and 126 may include virtual or physical computing devices (e.g., physical computers, virtual machines, containers, etc.). The network system 100 also includes a controller 130 to manage the network fabric 110.

The controller 130 includes a discovery service 140 configured to determine the topology of the network elements in the network fabric 110. The controller 130 also includes an endpoint management module 150 that is configured to store attributes of the endpoints 120, 122, 124, and 126 that are connected to the network fabric 110. Availability tracking logic 160 in the controller 130 enables the controller 130 to measure, monitor, and report network availability between any two endpoints connected to the network fabric 110 (e.g., any two endpoints among endpoints 120, 122, 124, and 126). The controller 130 is also in communication with an endpoint policy database 170 via an Application Programming Interface (API) gateway 175. The endpoint policy database 170 stores policy information associated with each endpoint connected to the network fabric 110.

In one example, the controller 130 acts as a single point of configuration, monitoring and management. The controller 130 maintains an awareness of the network elements in the network fabric 110, as well as the topology in which all of the network elements are connected to each other. In self-provisioning network fabrics, as soon as a network node is connected to the network fabric 110, the new network node connects to neighboring nodes and notifies the controller 130 of the new network node. The notification to the controller 130 of the new network node through the discovery service 140 may be made through one or more standardized protocols (e.g., Link Layer Discovery Protocol (LLDP), Intermediate System-Intermediate System (IS-IS), Dynamic Host Configuration Protocol (DHCP)) and/or proprietary discovery protocols.

In another example, when the network fabric 110 is initialized, the discovery service 140 may iteratively discover nodes starting from nodes neighboring the controller 130. In the next iteration, the controller 130 discovers neighbors of previously discovered nodes. This process may be repeated until the controller 130 discovers all of the nodes in the network fabric 110. In each iteration, the controller 130 may identify articulation points (i.e., network elements that present a single point of failure) and/or isolated bridges (i.e., network links that present a single point of failure). Removal or failure of a node of the network topology identified as an articulation point leads to the formation of a disconnected graph. Similarly, removal or failure of network links identified as an isolated bridge leads to a disconnected graph. The presence of articulation points and isolated bridges in the network topology of the network fabric 110 results in zero redundancy paths between some endpoints in the network fabric 110.

In a further example, the controller 130 may use the discovery data from the discovery service 140 and constructs a network graph with vertices of the graph being network elements and edges of the graph being network links between the network elements. For instance, a sub-module of the availability tracking logic 160 may update the network graph whenever a network element or network link is added or removed. Based on changes to the network graph, the availability tracking logic 160 may identify the presence of articulation points or isolated bridges to identify weaknesses in the network fabric 110.

In one example of generating an undirected, connected graph of the network topology of the network fabric 110, the root of the graph may be the first network element to join the network fabric 110. The sub-module of the availability tracking logic 160 in the controller 130 may run a path computation algorithm on an event basis, such as when network elements or network links are added or removed from the network fabric 110.

In another example, the availability tracking logic 160 enables the controller 130 to generate a metric of high network availability between pairs of endpoints in the network fabric 110. For instance, a pair of endpoints may be defined to have high network availability if there are two or more completely distinct paths between the endpoints, with no network node or link shared between the two paths. The metric of network availability may track the percentage of time that two or more distinct network paths exists between the two endpoints, as well as topology changes that lead to loss of high network availability. Tracking the metric of network availability may assist the controller 130 to identify and mitigate unstable network links and/or network nodes in the network fabric 110.

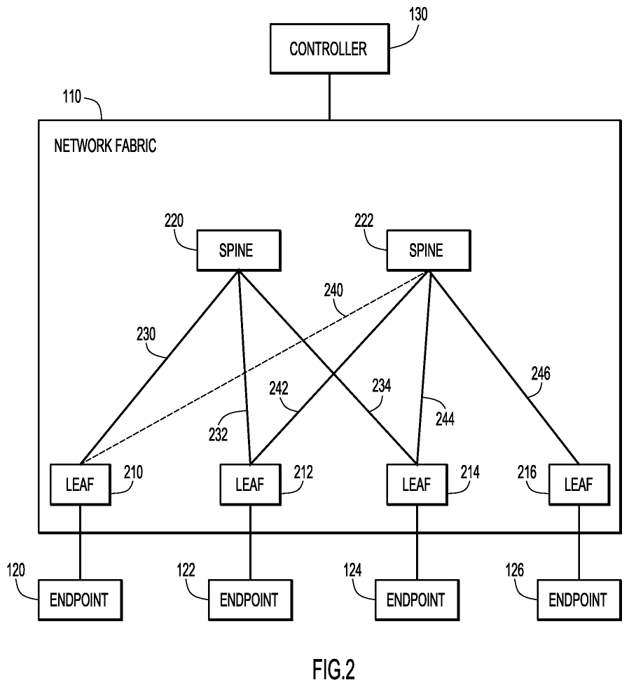

Referring now to FIG. 2, an example of the network elements in the network fabric 110 is shown. The network fabric 110 includes leaf nodes 210, 212, 214, and 216 that connect to endpoints 120, 122, 124, and 126, respectively. The network fabric 110 also includes two spine nodes 220 and 222 that are configured to connect two or more of the leaf nodes 210, 212, 214, and 216. The spine node 220 is connected to leaf nodes 210, 212, and 214 by links 230, 232, and 234, respectively. Spine node 222 is connected to leaf nodes 210, 212, 214, and 216 by links 240, 242, 244, and 246, respectively.

In the example shown in FIG. 2, the link 246 is an isolated bridge (i.e., a single point of failure in a network link) to the leaf node 216 connecting the endpoint 126 to the network fabric 110. The isolated bridge of link 246 negatively affects the metric of network availability of any pair of endpoints that includes endpoint 126. Additionally, the link 240 between the spine node 222 and the leaf node 210 is unstable and may fail, severing communication between the spine node 222 and the leaf node 210. The loss of network link 240 affects the high network availability of endpoint 120, since the leaf node 210 connecting the endpoint 120 to the network fabric 110 no longer has direct access to the spine node 222. Specifically, the loss of the network link 240 causes the spine node 220 to be an articulation point (i.e., a single point of failure network element) for communication between endpoint 120 and endpoint 122.

In another example, the controller 130 may discover the single points of failure in a two pass process. In the first pass, articulation points (e.g., spine node 220) are determined by dividing the network graph into bi-connected components. The controller 130 discovers isolated bridges in the second pass through the network topology. In a modern data center, duplicate network links may be used between nodes to increase bandwidth. To simplify the discovery process, the controller 130 may initially disregard duplicate links for the graph traversal. If the controller 130 discovers an isolated bridge, the controller 130 may determine if the isolated bridge has a duplicate network link. The controller 130 may only treat the discovered isolated bridge as a single point of failure if the network link does not have duplicate redundant links.

The controller 130 may divide the network graph into differently labeled sub-components based on the single points of failure discovered by the controller 130. If any traffic flows between differently labeled sub-components of the network graph, then the traffic is on a path of zero redundancy. Since the controller 130 quickly identifies articulation points and isolated bridges in the network fabric 110 based on unfavorable changes in the network topology, the controller 130 may raise a fault of high severity and notify a network administrator about the flaw in the network fabric 110. Additionally, the controller may adjust the metric of high availability. The network administrator may respond to the fault (e.g., by adding redundant links/nodes) to maintain the network fabric 110 with a high availability.

In a further example, the controller 130 may include an endpoint manager (e.g., endpoint management module 150 shown in FIG. 1) that may store a list of all endpoints (e.g., endpoints 120, 122, 124, and 126) connected to the network fabric 110, as well as the network element (E.g., leaf nodes 210, 212, 214, and 216) connecting each endpoint to the network fabric 110. Typically, a distributed endpoint database is maintained at the spine layer to track all endpoints connected to the network fabric 110 and disseminate endpoint reachability information to the leaf layer as needed. A simplified form of the endpoint database, e.g., with only essential attributes, may be maintained at the controller 130 to identify zero-redundancy scenarios between endpoint pairs. Additionally, the controller 130 may assign different priorities to endpoints and provide a policy to track and monitor particular endpoints in the network fabric. For instance, endpoint 120 and endpoint 124 may include resources that communicate to provide a particular service, and the controller 130 may prioritize maintaining non-zero redundancy between that endpoint pair.

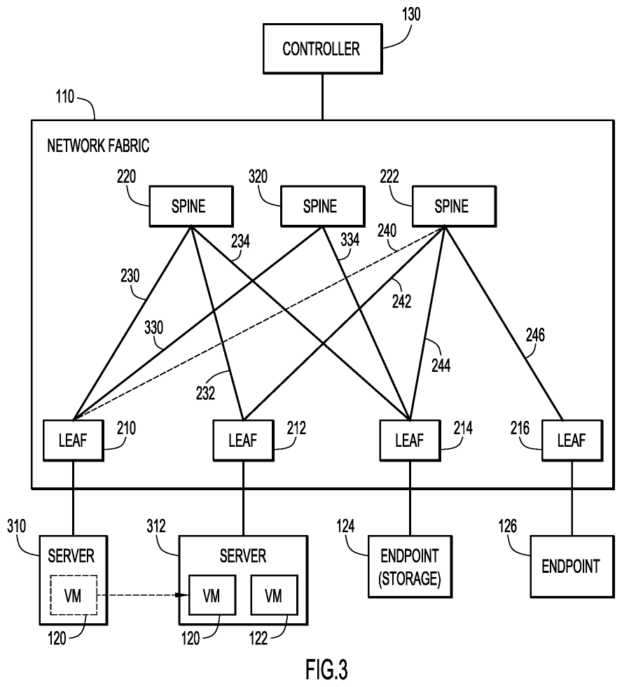

Referring now to FIG. 3, a simplified block diagram illustrates examples of remediation options for improving the metric of network availability between an application deployed on a Virtual Machine (VM) and a storage resource used by the application. In FIG. 3, the endpoint 120 is a VM initially deployed on a server 310 connected to the leaf node 210. The VM endpoint 120 includes the application that communicates with the storage resource in the endpoint 124. Similarly, the endpoint 122 is a VM deployed on a server 312 connected to the leaf node 212. When the network link 240 fails, the spine node 220 becomes an articulation point for traffic between the application in the endpoint 120 and the storage resource in the endpoint 124. Additionally, the network link 230 becomes an isolated bridge for traffic between the leaf node 210 and the leaf node 214.

The controller 130 detects the articulation point/isolated bridge and may present options to a network administrator to mitigate the zero redundancy data path between the endpoint 120 (i.e., the application VM) and the endpoint 124 (i.e., the corresponding storage resource). Alternatively, the controller 130 may automatically select an option without direct input form a network administrator. In the simplest option, the network administrator may be able to replace the failed network link 240 between the leaf node 210 and the spine node 222 to resolve the single point of failure.

In another option, the network administrator may migrate the endpoint 120 to the server 312, which is connected to the leaf node 212. Since the network fabric includes two distinct paths between the leaf node 212 and the leaf node 214, migrating the endpoint 120 in this way removes the single point of failure and improves the metric of network availability for the pair of endpoints (i.e., endpoints 120 and 124).

In a further option, the network administrator may add an additional network element, such as spine node 320. Connecting the new spine node 320 to the leaf node 210 with a network link 330 and to the leaf node 214 with a network link 334 removes the single point of failure between the leaf node 210 and the leaf node 214. With two distinct data paths between the leaf node 210 and the leaf node 214, the endpoint 120 may remain on the server 310 that is connected to the leaf node 210 while maintaining a non-zero redundancy to the storage resource on the endpoint 124 connected to the leaf node 214.

In one example, when the controller 130 discovers an articulation point or an isolated bridge in the network topology, automated scripts may automatically maintain services without manual intervention from an administrator. An administrator may fix the problem causing the articulation point or isolated bridge at a later time. For instance, automated scripts in the controller 130 may identify the leaf nodes affected by the articulation point/isolated bridge. Using an endpoint manager (e.g., endpoint management module 150 shown in FIG. 1) the controller 130 may identify endpoint pairs that are affected by the identified leaf nodes. When checking for zero-redundancy scenarios, the controller 130 may classify endpoints into multihomed endpoints and non-multihomed endpoints. Multihomed endpoints connect to at least two different leaf nodes for redundancy. The controller 130 may include a post-processing step to handle computation of redundant paths between multihomed endpoints.

In another example, the controller 130 may monitor the speed and/or bandwidth of the network links in the network fabric 110. The controller 130 may adjust the metric of network availability based on each independent network path having a minimum performance value that may be user specified. Ensuring that each independent path has sufficient bandwidth enables the network fabric 110 to maintain sufficient bandwidth between endpoint pairs in the event that one of the paths fails. Additionally, the controller 130 may include additional criteria, such as the number of hops between a particular endpoint pair, in the computation of the metric of network availability associated with that particular endpoint pair.

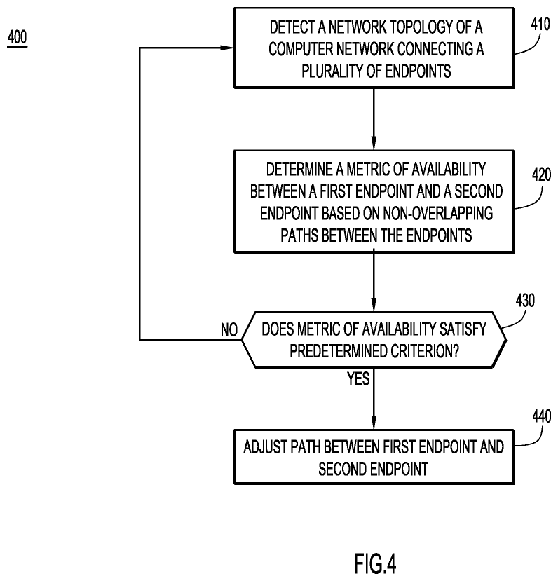

Referring now to FIG. 4, a flowchart illustrates operations performed by a network controller (e.g., controller 130) in a process 400 to track network availability between endpoints in order to maintain high network availability between two endpoints. At 410, the controller detects a topology of a computer network connecting a plurality of endpoints. In one example, the controller iteratively generates a graph of the network to detect the topology of the network.

At 420, the controller determines a metric of availability between a first endpoint and a second endpoint based on non-overlapping paths between the first endpoint and the second endpoint. In one example, the non-overlapping paths do not include any network elements or network links in common other than the network elements that connect the first endpoint or the second endpoint to the network fabric. In another example, the metric of availability may be based on attributes of the non-overlapping paths, such as bandwidth and/or latency.

At 430, the controller determines whether the metric of availability satisfies a predetermined criterion, e.g., a threshold for unacceptable network availability. In one example, the metric of availability satisfying the predetermined criterion may indicate that there is a single point of failure (e.g., an articulation point or an isolated bridge) between the first endpoint and the second endpoint. In another example, the predetermined criterion may be based on the available bandwidth for one or more of the non-overlapping paths decreasing below a value associated with a policy for the first endpoint and the second endpoint. For instance, a policy entry may indicate that the paths between the first endpoint and the second endpoint should be able to sustain at least a predetermined throughput, such as 10 Gigabits/sec (Gbit/s). If any of the non-overlapping paths do not meet the policy throughput limit, then the controller may disregard that network route from consideration for the metric of availability between the first endpoint and the second endpoint.

If the controller determines that the metric of availability does not satisfy the predetermined criterion, then the controller returns to monitor the topology of the computer network for additional changes that may affect the metric of availability. If the controller determines that the metric of availability does satisfy the predetermined criterion, then the controller adjusts the path between the first endpoint and the second endpoint at 440. In one example, the controller may add additional network elements and/or network links to the network fabric to adjust the path between the first endpoint and the second endpoint. In another example, the controller may cause one or both endpoints to connect to the network fabric at a different element in such a way that there are redundant paths between the endpoints to restore the metric of availability for the endpoint pair. For instance, the controller may direct a virtual machine endpoint to migrate to a server that is connected to the network fabric at a different network element that has more functioning connections to the rest of the network fabric.

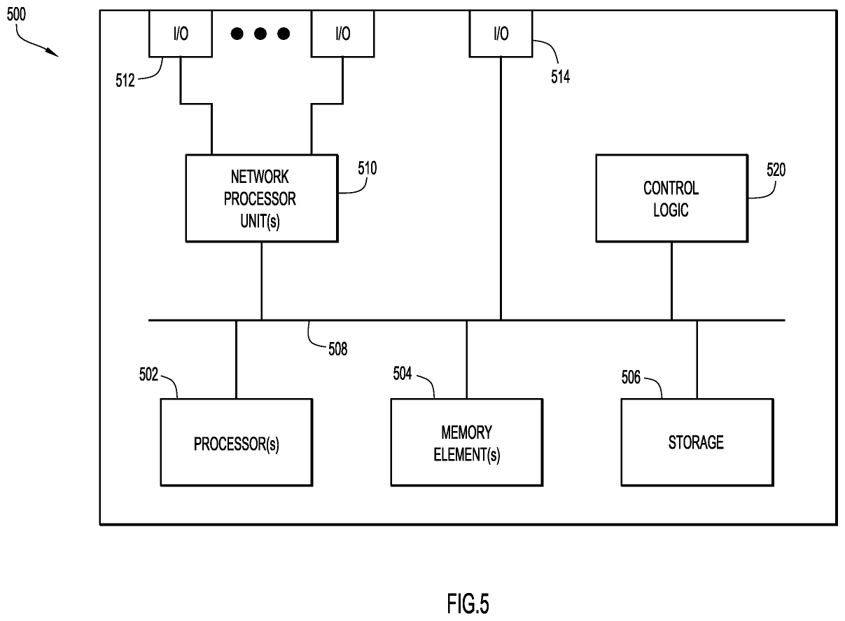

Referring to FIG. 5, FIG. 5 illustrates a hardware block diagram of a computing device 500 that may perform functions associated with operations discussed herein in connection with the techniques depicted in FIGS. 1-4. In various embodiments, a computing device, such as computing device 500 or any combination of computing devices 500, may be configured as any entity/entities as discussed for the techniques depicted in connection with FIGS. 1-4 in order to perform operations of the various techniques discussed herein.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computer device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In summary, the presence of single points of failure in a network fabric leads to application downtime. The techniques presented herein provide a dynamic method to identify such single points of failure before a complete failure of the application, enabling a network administrator to proactively reinforce the network topology and prevent network partition issues. This may be particularly useful to ensure high network availability between server-storage endpoint pairs using RoCEv2/TCP as the transport mechanism. Additionally, monitoring and maintaining high network availability between members of a distributed network controller or user application clusters may prevent network partitions that would lead to complex and costly remediation and repair efforts after an unexpected network failure.

In one form, a computer-implemented method is provided for maintaining network availability between an endpoint pair. The method includes detecting a topology of a computer network connecting a plurality of endpoints. The method also includes determining a metric of availability between a first endpoint of the plurality of endpoints and a second endpoint of the plurality of endpoints. The metric of availability is based on non-overlapping paths between the first endpoint and the second endpoint. Responsive to a determination that the metric of availability satisfies a predetermined criterion, the method includes adjusting a path between the first endpoint and the second endpoint.

In another form, an apparatus comprising a network interface and a processor is provided. The network interface is configured to communicate in a computer network. The processor is coupled to the network interface, and configured to detect a topology of the computer network that connects a plurality of endpoints. The processor is also configured to determine a metric of availability between a first endpoint of the plurality of endpoints and a second endpoint of the plurality of endpoints. The metric of availability is based on non-overlapping paths between the first endpoint and the second endpoint. Responsive to a determination that the metric of availability satisfies a predetermined criterion, the processor is configured to adjust a path between the first endpoint and the second endpoint.

In still another form, a non-transitory computer readable storage media is provided that is encoded with instructions that, when executed by a processor, cause the processor to detect a topology of a computer network connecting a plurality of endpoints. The instructions also cause the processor to determine a metric of availability between a first endpoint of the plurality of endpoints and a second endpoint of the plurality of endpoints. The metric of availability is based on non-overlapping paths between the first endpoint and the second endpoint. Responsive to a determination that the metric of availability satisfies a predetermined criterion, the instructions cause the processor to adjust a path between the first endpoint and the second endpoint.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
detecting a network topology of a computer network connecting a plurality of endpoints;
determining a metric of availability for a first endpoint of the plurality of endpoints and a second endpoint of the plurality of endpoints, the metric of availability based on a number of non-overlapping paths between the first endpoint and the second endpoint, wherein each non-overlapping path is a distinct path that does not share network elements and network links with another non-overlapping path; and
responsive to a determination that the metric of availability satisfies a predetermined criterion, adjusting a path between the first endpoint and the second endpoint.

2. The method of claim 1, wherein adjusting the path between the first endpoint and the second endpoint comprises adjusting one or more network elements in the computer network.

3. The method of claim 1, wherein adjusting the path between the first endpoint and the second endpoint comprises migrating the first endpoint or the second endpoint to connect to the computer network at a different network element.

4. The method of claim 1, wherein determining the metric of availability comprises generating an undirected connected graph of the network topology with network elements as vertices in the undirected connected graph and with network links as edges in the undirected connected graph.

5. The method of claim 4, wherein determining the metric of availability further comprises:
determining whether one or more articulation points exist in the network elements between the first endpoint and the second endpoint; and
determining whether one or more bridges exist in the network links between the first endpoint and the second endpoint.

6. The method of claim 1, further comprising storing attributes of the plurality of endpoints connected to the computer network.

7. The method of claim 1, further comprising storing policy entries associating a respective criterion for the metric of availability with a corresponding pair of endpoints among the plurality of endpoints.

8. An apparatus comprising:
a network interface configured to communicate in a computer network; and
a processor coupled to the network interface, the processor configured to:
detect a network topology of the computer network that connects a plurality of endpoints;
determine a metric of availability for a first endpoint of the plurality of endpoints and a second endpoint of the plurality of endpoints, the metric of availability based on a number of non-overlapping paths between the first endpoint and the second endpoint, wherein each non-overlapping path is a distinct path that does not share network elements and network links with another non-overlapping path; and
responsive to a determination that the metric of availability satisfies a predetermined criterion, adjust a path between the first endpoint and the second endpoint.

9. The apparatus of claim 8, wherein the processor is configured to adjust the path between the first endpoint and the second endpoint by adjusting one or more network elements in the computer network.

10. The apparatus of claim 8, wherein the processor is configured to adjust the path between the first endpoint and the second endpoint by migrating the first endpoint or the second endpoint to connect to the computer network at a different network element.

11. The apparatus of claim 8, wherein the processor is configured to determine the metric of availability by generating an undirected connected graph of the network topology with network elements as vertices in the undirected connected graph and with network links as edges in the undirected connected graph.

12. The apparatus of claim 11, wherein the processor is configured to determine the metric of availability by:
determining whether one or more articulation points exist in the network elements between the first endpoint and the second endpoint; and
determining whether one or more bridges exist in the network links between the first endpoint and the second endpoint.

13. The apparatus of claim 8, further comprising an endpoint management database configured to store attributes of a plurality of endpoints connected to the computer network.

14. The apparatus of claim 8, further comprising a policy database configured to store policy entries associating a respective criterion for the metric of availability with a corresponding pair of endpoints from the plurality of endpoints connected to the computer network.

15. One or more non-transitory computer readable storage media encoded with software comprising computer executable instructions and, when the software is executed, it is operable to cause a processor to:
detect a network topology of a computer network connecting a plurality of endpoints;
determine a metric of availability for a first endpoint of the plurality of endpoints and a second endpoint of the plurality of endpoints, the metric of availability based on a number of non-overlapping paths between the first endpoint and the second endpoint, wherein each non-overlapping path is a distinct path that does not share network elements and network links with another non-overlapping path; and
responsive to a determination that the metric of availability satisfies a predetermined criterion, adjust a path between the first endpoint and the second endpoint.

16. The one or more non-transitory computer readable storage media of claim 15, wherein the software is further operable to cause the processor to adjust the path between the first endpoint and the second endpoint by adjusting one or more network elements in the computer network.

17. The one or more non-transitory computer readable storage media of claim 15, wherein the software is further operable to cause the processor to adjust the path between the first endpoint and the second endpoint by migrating the first endpoint or the second endpoint to connect to the computer network at a different network element.

18. The one or more non-transitory computer readable storage media of claim 15, wherein the software is further operable to cause the processor to determine the metric of availability by generating an undirected connected graph of the network topology with network elements as vertices in the undirected connected graph and with network links as edges in the undirected connected graph.

19. The one or more non-transitory computer readable storage media of claim 18, wherein the software is further operable to cause the processor to determine the metric of availability by:
determining whether one or more articulation points exist in the network elements between the first endpoint and the second endpoint; and
determining whether one or more bridges exist in the network links between the first endpoint and the second endpoint.

20. The one or more non-transitory computer readable storage media of claim 15, wherein the software is further operable to cause the processor to store attributes of a plurality of endpoints connected to the computer network in an endpoint management database.
